(19) United States
(12) Patent Application Publication
(10) Pub. No.: US 2001/0007459 A1
(43) Pub. Date: Jul. 12, 2001

(54) Wiping device for ink jet head

(76) Inventor: Masaru Midorikawa, Chiba-shi (JP)

Correspondence Address: ADAMS & WILKS, 31st Floor, 50 Broadway, New York, NY, 10004, US

(21) Appl. No.: 09/754,646

(22) Filed: Jan. 4, 2001

(30) Foreign Application Priority Data
Jan. 7, 2000 (JP) 2000-005939

(51) Int. Cl. B41J 2/165

(52) U.S. Cl. 347/33

(57) ABSTRACT

A wiping device for an ink jet head is provided, which can simultaneously achieve two objects, i.e. extended service life of the ink jet head and effective removal of viscosity-increased and adhered ink with a single wiping device. A wiping device (2) has a predetermined level difference between an upper end level of a first side surface (6a) and an upper end level of a second side surface (6b) on a wiper blade holder (6) clamping a wiper blade (4). The upper end of the first side surface (6a) of the wiper blade holder (6) is set to such a predetermined level that can provide a normal, weak wiping effect. That is, a free length (La) of the first side surface (4a) of the wiper blade (4) is set to have such a predetermined length that can provide the normal, weak wiping effect. The upper end of the second side surface (6b) of the wiper blade holder (6) is set to such a predetermined level that can provide an abnormal, strong wiping effect. That is, a free length (Lb) of the second side surface (4b) of the wiper blade (4) is set to have such a predetermined length that can provide the abnormal, strong wiping effect.

### BACKGROUND OF THE INVENTION

1. Field of the Invention

The present invention relates to a wiping device for an ink jet head, and more particularly, to a wiping device for an ink jet head, in which the magnitude of a pressure contact force by a free end of a wiper blade with an ink jet ejection surface of the ink jet head may be changed into two stages.

2. Description of the Related Art

A conventional wiping device is known which includes a wiper blade made of an elastic member such as acrylonitrile-butadience rubber (hereafter, simply referred to as NBR) and a fluorine rubber, and a wiper blade holder partially clamping both side surfaces of the wiper blade. The wiping device serves such that the wiper blade and an ink jet head are relatively moved while the free end of the wiper blade is pressure contacted with an ink ejection surface of an ink jet head, thereby cleaning the ejection surface.

The conventional wiping device generally is classified into the following two systems.

The first system is shown in FIG. 6 which is a perspective view and FIGS. 7A to 7E which are elevational views of an activated state. As shown in FIG. 6 and FIGS. 7A to 7E, a wiping device 52 for an ink jet head 50 classified into this system, includes moving means (not shown) for reciprocatingly (vertically) moving a wiper blade holder 54 in a direction (an arrow direction indicated by “h” in FIG. 6, a vertical direction in FIG. 7) perpendicular to a scanning direction of the ink jet head 50. The wiper blade holder 54 is moved vertically upwardly in an arrow “k” direction in FIG. 7B, and in a state in which a leading end (a free end) of a wiper blade 56 is positioned to be pressure contacted with an ink ejection surface 50ns of the ink jet head 50 (see FIG. 7B, the ink jet head 50 is scanned in its widthwise direction (in an arrow “g” direction in FIG. 6, in an arrow “m” direction in FIG. 7) (see FIG. 7C and FIG. 7D), whereby the ink ejection surface 50ns is cleaned. Here, the head 50 is scanned in the widthwise direction of the ink jet head, i.e. in the arrow “g” direction in FIG. 6 by a head conveying belt 51c while being guided by guide shafts 51a and 51b passing through a pair of guide holes 50ha and 50hb parallelly perforated through the lower portion of the head 50.

Reference symbols “A” to “D” in FIG. 6 and FIGS. 7A to 7E denote caps, which after the wiping action for the ink jet head 50 is completed, are moved vertically upwardly so that the upper ends thereof are contacted with the ink ejection surface 50ns of the ink jet head 50. This allows the ink ejection surface 50ns to be kept in a wet state, or to be sealed from the exterior for a vacuum suction when an ink is initially charged into or forcibly ejected from the ink jet head 50.

In this system, the common wiper blade 56 is used to wipe the ink ejection surface of the ink jet head corresponding to all colors, so that there arises a problem of mixing colors.

The other second system, intended to solve the color mixing problem encountered in the first system, is shown in FIG. 8 which is a perspective view. As shown in FIG. 8, a wiping device 60 for the ink jet head 50, classified into this system, includes a wiper blade unit 66 having a wiper blade 62 extending in the widthwise direction (in the arrow “g” direction in the drawing) of the ink jet head 50, and a wiper blade holder 64 clamping the wiper blade 62, and moving means 68 for reciprocatingly moving the wiper blade unit 66 in the direction (in an arrow “r” direction in FIG. 8) perpendicular to the scanning direction of the ink jet head 50.

The moving means 68 includes a pair of right and left wiper conveying belts 70 and 70 having upper surfaces to which the wiper blade unit 66 is fixed, drive pulleys 72 and 72 and driven pulleys 74 and 74, on which the right and left wiper conveying belts are suspended, and a gear train 78 provided between a rotational shaft for the drive pulleys 72 and 72 and a rotational shaft of a wiper driving motor 76. The free end of the wiper blade 62 is positioned to be pressure contacted with the ink ejection surface 50ns of the ink jet head 50. Here, the head 50 is scanned in the widthwise direction of the ink jet head, i.e. in the arrow “g” direction in FIG. 6 by the head conveying belt 51c while being guided by the guide shafts 51a and 51b passing through the pair of guide holes 50ha and 50hb parallelly perforated through the lower portion of the head 50.

In the system thus constructed, the ink jet head 50 is positioned just above the wiping device 60, and the wiper blade unit 66 is scanned in the longitudinal direction (in the arrow “s” direction in FIG. 8) of the ink jet head 50, thereby cleaning the ink ejection surface 50ns.

Reference numerals A to F in FIG. 8 denote caps, which after the wiping action for the ink jet head 50 is completed, are moved vertically upwardly so that the upper ends thereof are contacted with the ink ejection surface 50ns of the ink jet head 50. This allows the ink ejection surface 50ns to be kept in a wet state, or to be sealed from the exterior for a vacuum suction when an ink is initially charged into or forcibly ejected from the ink jet head 50.

The wiping device 52 for the ink jet head 50, classified into the first system, is designed, as shown in FIG. 9A, such that the both surfaces 56a and 56b of the wiper blade 56 are clamped respectively by the both side surfaces 54a and 54b of the wiper blade holder 54 up to the same level. Consequently, the non-clamped, free lengths of the wiper blade 56, i.e. the length La and the length Lb from the upper end of both side surfaces 54a and 54b of the wiper blade holder 54 to the free end of the wiper blade 56, are equal to each other.

The wiping device 60 for the ink jet head 50, classified into the second system, is designed, as shown in FIG. 9B, such that the both surfaces 62a and 62b of the wiper blade 62 are clamped respectively by a wiper blade holder main plate 64a of the wiper blade holder 64 and a wiper blade holder sub plate 64b thereof up to the same level. Consequently, the non-clamped, free lengths of the wiper blade 62, i.e. the length La and the length Lb from the upper end of the wiper blade holder 64 to the free end of the wiper blade 62 on both side surfaces 64a and 64b, are equal to each other.

Besides, in a case where ink, dust, or the like adhered to the ink ejection surface of the ink jet head is close to an ejection nozzle, ink ejected therefrom is attracted to the ink, dust, or the like, thereby causing print failure. To avoid this print failure, the wiping device 52 or the wiping device 60 is activated at a predetermined time interval or at predetermined number of times the ink jet head is reciprocated, so as to clean the ink ejection surface 50ns of the ink jet head 50. As the time interval is smaller or as the number of times the ink jet head is reciprocated is smaller, the wiping action by the wiping device 52 or 60 is effective to achieve stable and straight ink ejection, but if the wiping action is frequently performed, a water repellent film formed on the ink ejection surface 50ns may be worn, resulting in lowering of service life of the ink jet head.

There is a very rare case that if the ejection surface 50ns of the ink jet head 50 is left uncovered by the caps A to D or A to F, ink, the viscosity of which is increased due to evaporation of moisture content in a case of water based ink, or adhering of dust in a case of fixed oil based ink, is adhered onto the ink ejection surface 50ns, so that the adhered material cannot be easily wiped out by the normal wiping action. In this case, larger pressure contact force of the wiper blade 56 or 62 with the ink ejection surface 50ns is effective, but if the wiping action with the larger pressure contact force is preformed constantly, the wearing of the water repellent surface is promoted similarly, making the service life of the ink jet head shorter.

The wiping devices for the ink jet heads classified into the two systems mentioned above are activated with the pressure contact force of only one stage, and consequently suffers from a problem in that each of the devices cannot simultaneously achieve two objects, i.e. extended service life of the ink jet head and removal of viscosity-increased and adhered ink.

### SUMMARY OF THE INVENTION

Accordingly, the present invention has been made to solve the above-mentioned problem inherent in the conventional arts, and therefore has an object to provide a wiping device for an ink jet head, which can enable wiping action with a pressure contact force of two strong and weak stages, thereby simultaneously achieving the two objects, i.e. elongated service life of the ink jet head and removal of viscosity-increased and adhered ink with a single wiping device.

According to a first aspect of the present invention, there is provided a wiping device for an ink jet head, comprising:

a wiper blade made of an elastic member; and

a wiper blade holder partially clamping both side surfaces of the wiper blade,

characterized in that the wiper blade and the ink jet head are relatively moved while a free end of the wiper blade is pressure contacted with an ink ejection surface on the ink jet head, thereby wiping the ejection surface, and

that a predetermined level difference is provided between an upper end level of one side surface of the wiper blade holder and an upper end level of the other side surface of the wiper blade holder.

According to a second aspect of the present invention, in the first aspect of the invention, a wiping device for the ink jet head further comprises moving means for moving the wiper blade holder back and forth in a direction perpendicular to a scanning direction of the ink jet head, and characterized in that, in a state where the wiper blade holder is positioned so that the free end of the wiper blade is contactable with the ink ejection surface of the ink jet head, the ink jet head is scanned in its widthwise direction reciprocatingly or selectively in one-way manner, thereby wiping the ink ejection surface.

According to a third aspect of the present invention, in the first aspect of the invention, a wiping device for the ink jet head further comprises moving means for moving the wiper blade holder back and forth in a longitudinal direction of the ink jet head, and characterized in that, in a state where the wiper blade holder is positioned so that the free end of the wiper blade is contactable with the ink ejection surface of the ink jet head, the wiper blade holder is moved in the longitudinal direction selectively back and forth, thereby wiping the ink ejection surface.

(Effect)

Each of the first to third aspects provides the following effects.

That is, the predetermined level difference is provided between the upper end level of the first side surface of the wiper blade holder and the upper end level of the second side surface thereof.

The upper end of the first side surface of the wiper blade holder is set to such a predetermined level that can provide a normal, weak wiping effect. That is, a free length of the first side surface of the wiper blade is set to have such a predetermined length that can provide the normal, weak wiping effect.

The upper end of the second side surface of the wiper blade holder is set to such a predetermined level that can provide an abnormal, strong wiping effect. That is, a free length of the second side surface of the wiper blade is set to have such a predetermined length that can provide the abnormal, strong wiping effect.

In a case where the normal wiping action is carried out, the wiper blade and the ink ejection surface of the ink jet head are relatively moved in such a direction that the wiper blade is bent toward the first side surface side. Since the free length of the first side surface is long, this facilitates the bending, and allows the wiper blade to be pressure contacted with the ink ejection surface with the normal, weak pressure contact force, thereby providing the weak wiping effect.

In a case of an abnormal state, for example, in a case where the wiping action is manually carried out when a print failure occurs, it is found, as a result of position detection regarding the ink jet head, that the ink ejection surface is not covered by caps, etc., the wiping action is carried out so that the wiper blade and the ink ejection surface of the ink jet head are relatively moved in such a direction that the wiper blade is bent toward the second side surface side. The free length of the second side surface is shorter than that in the normal wiping action and thus the wiper blade is less bent. Accordingly, the wiper blade is pressure contacted with the ink ejection surface with the abnormal, strong pressure contact force, thereby providing the strong wiping effect.

As described above, the wiping action with the normal, weak pressure contact force and the wiping action with the abnormal, strong pressure contact force can be selectively used by simply reversing the relatively moving direction between the wiper blade and the ink ejection surface of the ink jet head. Therefore, it is possible to simultaneously achieve two objects, i.e. elongated service life of the ink jet head and removal of viscosity-increased and adhered ink with a single wiping device.

### BRIEF DESCRIPTION OF THE DRAWINGS

In the accompanying drawings:

FIG. 1 is a partially omitted, sectional view of a wiping device for an ink jet head according to a first embodiment of the present invention;

FIG. 2 is a schematic view for explaining a first action and operation of the wiping device for the ink jet head according to the first embodiment;

FIG. 3 is a schematic view for explaining a second action and operation of the wiping device for the ink jet head according to the first embodiment;

FIG. 4 is a partially omitted, sectional view of a wiping device for an ink jet head according to a second embodiment of the present invention;

FIG. 5A is a schematic view for explaining a first action and operation of the wiping device for the ink jet head according to the second embodiment, and FIG. 5B is a second action and operation of the wiping device for the ink jet head according to the second embodiment;

FIG. 6 is a perspective view showing a construction of a conventional wiping device for an ink jet head, which is classified into a first system;

FIG. 7 is a schematic view for explaining an action and operation of the conventional wiping device for the ink jet head, which is classified into the first system;

FIG. 8 is a perspective view showing a conventional wiping device for an ink jet head, which is classified into a second system; and

FIG. 9 shows structures of the wiper blade units in the conventional wiping devices for the ink jet heads, in which a part A is an enlarged sectional view of the first system, and a part B is an enlarged sectional view of the second system.

### DETAILED DESCRIPTION OF THE PREFERRED EMBODIMENTS

A first embodiment of the present invention will be described below with reference to the accompanying drawings.

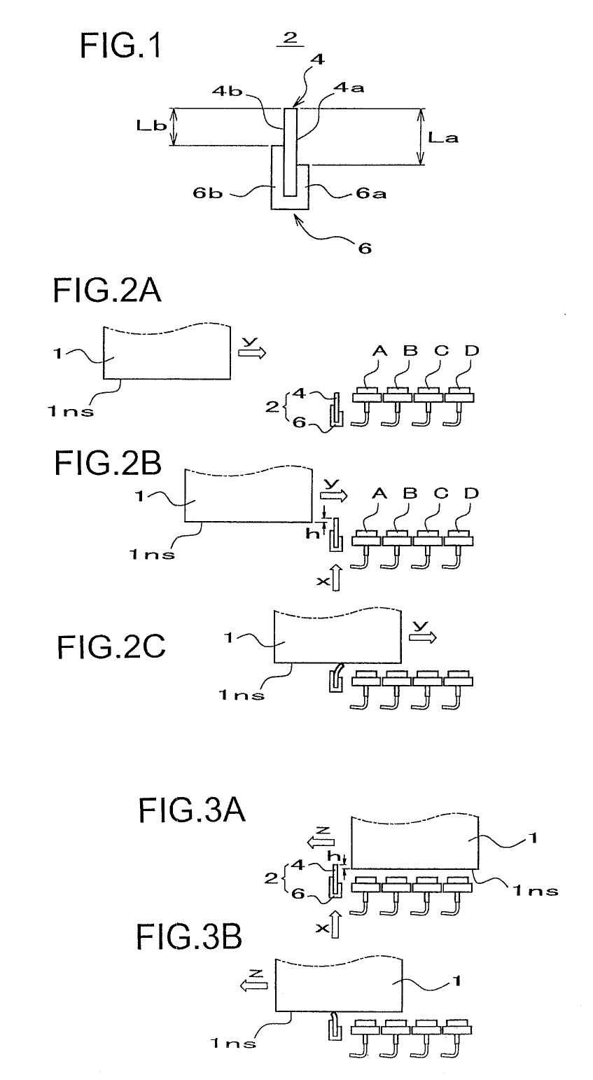

FIG. 1 is a partially omitted, sectional view of a wiping device for an ink jet head according to the first embodiment of the present invention. FIGS. 2A to 2C are schematic views for explaining a first action and operation of the wiping device for the ink jet head according to the first embodiment. FIGS. 3A and 3B are schematic views for explaining a second action and operation of the wiping device for the ink jet head according to the first embodiment.

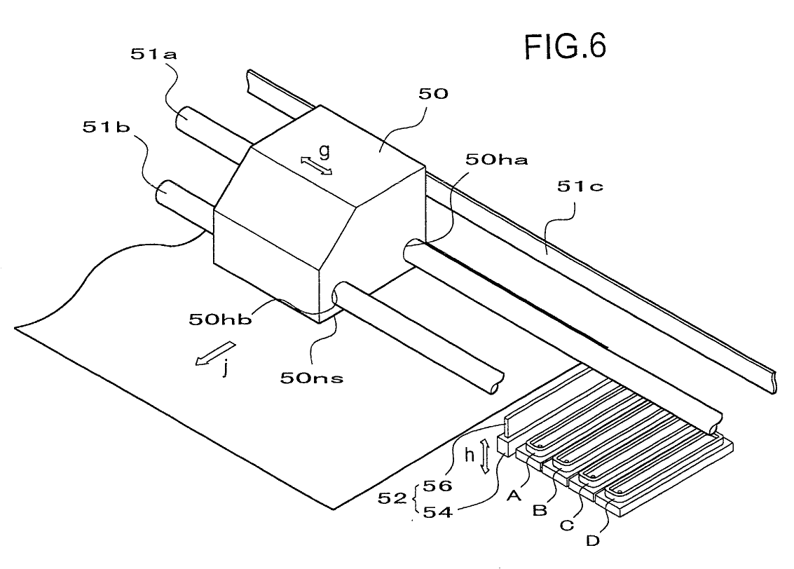

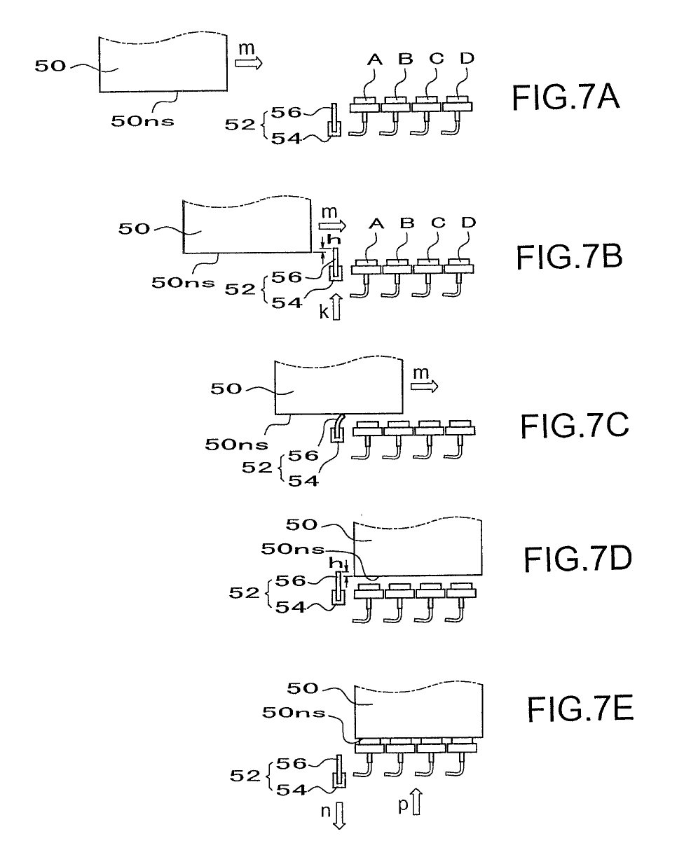

A wiping device 2 for an ink jet head 1 according to the first embodiment of the present invention is constructed such that the wiping device 52 for the ink jet head 50, classified into the first system and discussed with reference to FIG. 6 is replaced with the wiping device 2 shown in FIG. 1.

That is, as shown in FIG. 1, the wiping device 2 according to the present embodiment has a predetermined level difference between an upper end level of a first side surface 6a and an upper end level of a second side surface 6b on a wiper blade holder 6 clamping a wiper blade 4 made of an elastic member such as NBR and fluorine rubber.

The upper end of the first side surface 6a of the wiper blade holder 6 is set to such a predetermined level that can provide a normal, weak wiping effect. That is, a free length La of the first side surface 4a of the wiper blade 4 is set to have such a predetermined length that can provide the normal, weak wiping effect.

The upper end of the second side surface 6b of the wiper blade holder 6 is set to such a predetermined level that can provide an abnormal, strong wiping effect. That is, a free length Lb of the second side surface 4b of the wiper blade 4 is set to have such a predetermined length that can provide the abnormal, strong wiping effect.

Although not illustrated, moving means is provided, that reciprocatingly moves the wiper blade holder in a direction (in the vertical direction in FIG. 1) perpendicular to the scanning direction of the ink jet head. As the moving means (elevating means), a generally used, well-known mechanism can be used as long as it is simple in structure and compact in size. For example, a combination of an electric motor and a cam can be used.

Next, the action and operation of the wiping device 2 for the ink jet head 1 according to the first embodiment of the present invention as constructed above will be described.

A. In a case where the normal, weak wiping action is performed:

(1) From a state shown in FIG. 2A, i.e. a state in which the wiping device 2 is lowered at a stand-by position, the wiping device 2 is moved upwardly in an arrow “x” direction as shown in FIG. 2B so that the upper end (the free end) of the wiper blade 4 is positioned to be contactable with an ink ejection surface 1ns of the ink jet head 1 with a predetermined overlapping amount h.

(2) As shown in FIGS. 2B and 2C, the ink jet head 1 is moved in an arrow “y” direction. Consequently, as shown in FIG. 2C, the wiping action is carried out with the wiper blade 4 being bent toward the first surface 4a side, i.e. a side where the longer free length La is present. Since the free length La is long, the pressure contact force of the upper end (the free end) of the wiper blade by the elasticity of the wiper blade 4 with the ink ejection surface ins is weak.

B. In a case where the abnormal, strong wiping action is performed:

(1) As shown in FIG. 3A, the wiping device 2 is moved upwardly in the arrow “x” direction so that the upper end (the free end) of the wiper blade 4 is positioned to be contactable with the ink ejection surface 1ns of the ink jet head 1 with the predetermined overlapping amount h.

(2) As shown in FIGS. 3A and 3B, the ink jet head 1 is moved in an arrow “z” direction. Consequently, as shown in FIG. 3B, the wiping action is carried out with the wiper blade 4 being bent toward the second surface 4b side, i.e. a side where the shorter free length Lb is present. Since the free length Lb is short, the pressure contact force of the upper end (the free end) of the wiper blade by the elasticity of the wiper blade 4 with the ink ejection surface 1ns is strong.

Next, a second embodiment of the present invention will be described with reference to the accompanying drawings.

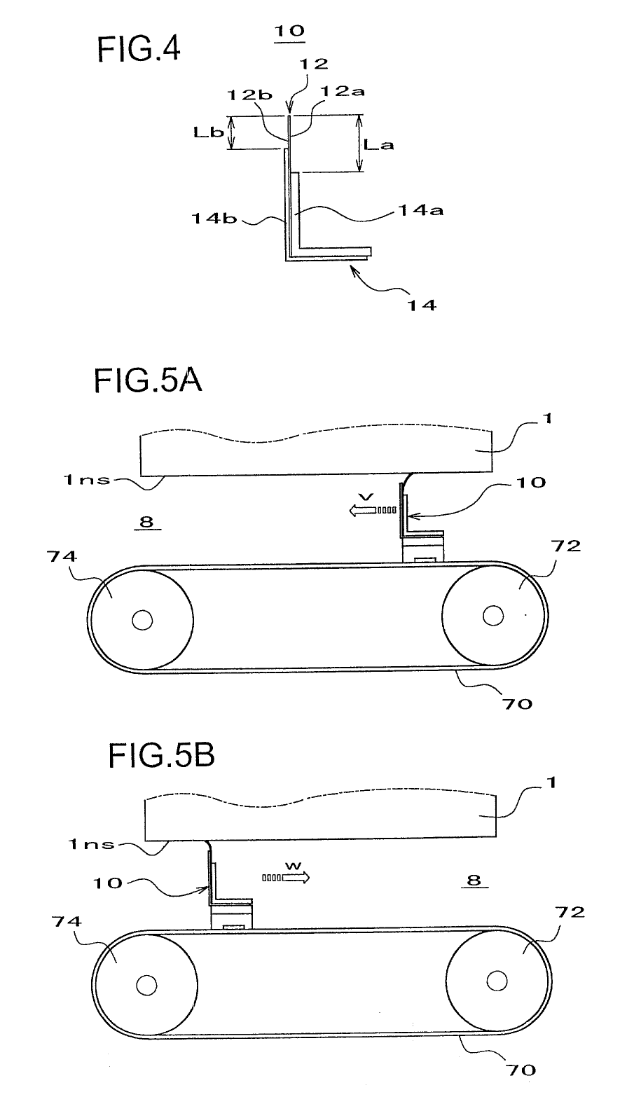

FIG. 4 is a partially omitted, sectional view of a wiping device for an ink jet head according to the second embodiment of the present invention. FIG. 5A is a schematic view for explaining a first action and operation of the wiping device for the ink jet head according to the second embodiment, and FIG. 5B is a second action and operation of the wiping device for the ink jet head according to the second embodiment.

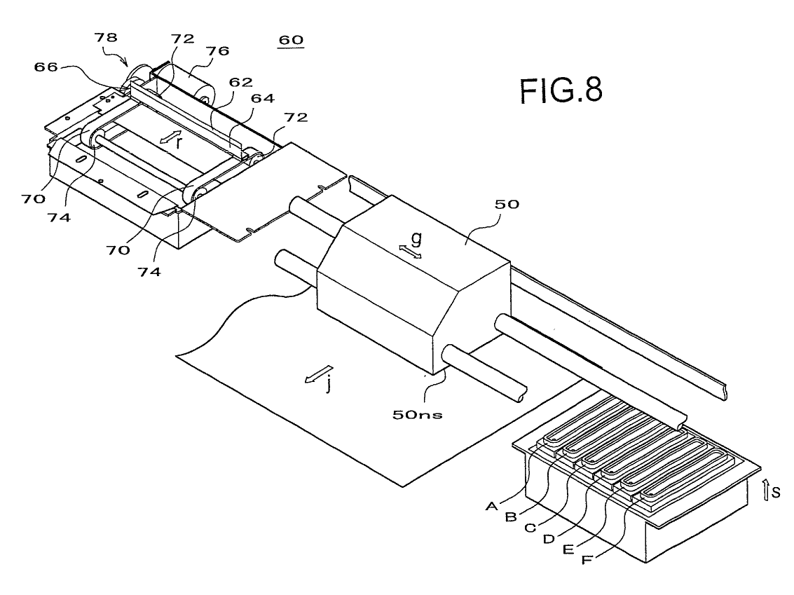

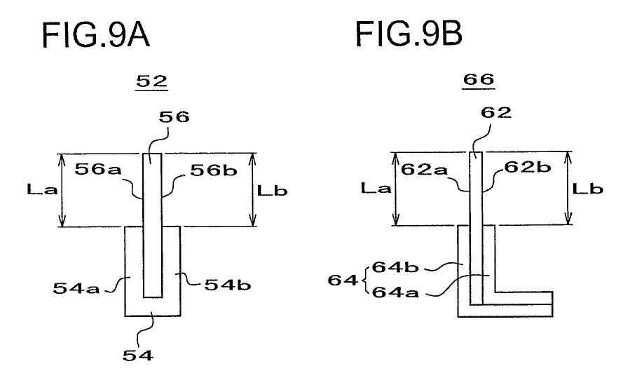

A wiping device 8 for the ink jet head 1 according to the second embodiment of the present invention is constructed such that the wiping unit 66 of the wiping device 62 for the ink jet head 50, classified into the second system and discussed with reference to FIG. 8 is replaced with a wiping unit 10 shown in FIG. 4.

That is, as shown in FIG. 4, the wiping unit 10 according to the present embodiment has a predetermined level difference between an upper end level of a first side surface (a wiper blade holder main plate) 14a and an upper end level of a second side surface (a wiper blade holder sub plate) 14b on a wiper blade holder 14 clamping a wiper blade 12 made of an elastic member, for example, NBR, fluorine rubber, etc.

The upper end of the first side surface 14a of the wiper blade holder 14 is set to such a predetermined level that can provide a normal, weak wiping effect. That is, a free length La of the first side surface 12a of the wiper blade 12 is set to have such a predetermined length that can provide the normal, weak wiping effect.

The upper end of the second side surface 14b of the wiper blade holder 14 is set to such a predetermined level that can provide an abnormal, strong wiping effect. That is, a free length Lb of the second side surface 12b of the wiper blade 12 is set to have such a predetermined length that can provide the abnormal, strong wiping effect.

As shown in FIGS. 5A and 5B, the wiper blade unit 10 is fixed to the surface of a wiper conveying belt 70 so that the upper end (the free end) of the wiper blade is positioned to be contactable with the ink ejection surface ins of the ink jet head 1 with a predetermined overlapping amount. By moving the wiper conveying belt 70 suspended between a drive pulley 72 and a driven pulley 74, the wiper blade unit 10 is reciprocatingly moved in the longitudinal direction of the ink jet head.

Next, the action and operation of the wiping device 8 for the ink jet head 1 according to the second embodiment of the present invention as constructed above will be described.

A. In a case where the normal, weak wiping action is performed:

The ink jet head 1 is positioned just above the wiping device 8, and then as shown in FIG. 5A the wiper blade unit 10 is moved in an arrow “v” direction. Consequently, as shown in FIG. 5A, the wiping action is carried out with the wiper blade 12 being bent toward the first surface 12a side, i.e. a side where the longer free length La is present. Since the free length La is long, the pressure contact force of the upper end (the free end) of the wiper blade 12 by the elasticity of the wiper blade 12 with the ink ejection surface 1ns is weak.

B. In a case where the abnormal, strong wiping action is performed:

The ink jet head 1 is positioned just above the wiping device 2, and then as shown in FIG. 5B, the wiping unit 12 is moved in an arrow “w” direction. Consequently, as shown in FIG. 5B, the wiping action is carried out with the wiper blade 12 being bent toward the second surface 12b side, i.e. a side where the shorter free length Lb is present. Since the free length Lb is short, the pressure contact force of the upper end (the free end) of the wiper blade 12 by the elasticity of the wiper blade 12, with the ink ejection surface 1ns is strong.

According to the present invention, by changing relatively moving direction between a wiper blade made of an elastic member and an ink jet head, a pressure contact force of a leading end (a free end) of the wiper blade with an ink ejection surface can be changed into two strong and weak stages.

As a result, in a case where a normal adhered material, such as ink, dust or the like on the ink ejection surface is wiped out, the wiping action is carried out with a weak pressure contact force and at a short time interval, thereby assuring stability of print quality.

In a case where an adhered material, such as viscosity-increased ink stuck to the ink ejection surface with a strong adhering force is removed, the wiping action can be carried out with a strong pressure contact force, thereby effectively removing the adhered material. Further, since the wiping action with the strong pressure contact force is not carried out constantly, the wiping device is free from a problem that the wearing of a water repellent surface on the ink ejection surface of the ink jet head is promoted and the service life of the ink jet head is shortened.

What is claimed is:

1. A wiping device for an ink jet head, comprising:
a wiper blade made of an elastic member; and
a wiper blade holder partially clamping both side surfaces of the wiper blade,
wherein the wiper blade and the ink jet head are relatively moved while a free end of the wiper blade is pressure contacted with an ink ejection surface on the ink jet head, thereby wiping the ejection surface, and
wherein a predetermined level difference is provided between an upper end level of one side surface of the wiper blade holder and an upper end level of the other side surface of the wiper blade holder.

2. A wiping device for the ink jet head according to claim 1, further comprising moving means for moving the wiper blade holder back and forth in a direction perpendicular to a scanning direction of the ink jet head, wherein, in a state where the wiper blade holder is positioned so that the free end of the wiper blade is contactable with the ink ejection surface of the ink jet head, the ink jet head is scanned in its widthwise direction reciprocatingly or selectively in a one-way manner, thereby wiping the ink ejection surface.

3. A wiping device for the ink jet head according to claim 1, further comprising moving means for moving the wiper blade holder back and forth in a longitudinal direction of the ink jet head, wherein, in a state where the wiper blade holder is positioned so that the free end of the wiper blade is contactable with the ink ejection surface of the ink jet head, the wiper blade holder is moved in the longitudinal direction selectively back and forth, thereby wiping the ink ejection surface.
